(19) United States
(12) Patent Application Publication
(10) Pub. No.: US 2022/0410991 A1
(43) Pub. Date: Dec. 29, 2022

(54) AUTONOMOUS ROBOT

(71) Applicant: Meropy, Meylan (FR)

(72) Inventors: Guillemin Raymond, Meylan (FR); William Guitton, Goncelin (FR)

(21) Appl. No.: 17/756,161

(22) PCT Filed: Oct. 16, 2020
(86) PCT No.: PCT/FR2020/051873

§ 371 Date: May 18, 2022

(30) Foreign Application Priority Data
Nov. 19, 2019 (FR) FR1912919

(51) Int. Cl. B62D 61/02; B60L 50/60; B62D 37/00; B60K 7/00; B60B 1/06

(52) U.S. Cl. CPC B62D 61/02; B60L 50/60; B62D 37/00; B60K 7/0007; B60B 1/06; G05D 1/0231

(57) ABSTRACT

An autonomous robot comprises: a body, that is elongated along an axis oriented transverse to a direction of movement of the robot and, connected to the elongated body, a multispectral sensor, precisely two wheels, and a stabilizing device for controlling the pitch of the elongated body when the wheels are in motion, the wheels being in the form of spoked wheels.

### CROSS-REFERENCE TO RELATED APPLICATIONS

This application is a national phase entry under 35 U.S.C. § 371 of International Patent Application PCT/FR2020/051873, filed Oct. 16, 2020, designating the United States of America and published as International Patent Publication WO 2021/099705 A1 on May 27, 2021, which claims the benefit under Article 8 of the Patent Cooperation Treaty to French Patent Application Serial No. FR1912919, filed Nov. 19, 2019.

### TECHNICAL FIELD

The present disclosure relates to an autonomous robot provided with a multispectral sensor. The present disclosure can be used, in particular, in the field of agriculture, specifically precision agriculture. Such robots are used, in particular, to establish and share a map of plots of land in order to carry out a diagnosis of the plot.

### BACKGROUND

Autonomous robots are currently used in agriculture to detect, within a plot, the nutritional needs of plants as well as the presence of bio-aggressors such as weeds, diseases, or pests.

To do this, the robots are equipped with detectors or imagers to carry out a diagnosis of the plot in the form of a map in order to allow the farmer to carry out precision interventions, save on inputs, and limit the impact on the environment while increasing the productivity of the crops in place.

Drones equipped with multispectral imaging devices are known from FR 3 006 296 and WO 2014/202777. These remotely piloted drones fly over agricultural plots to collect data and generate maps relating to a state of the agricultural crops.

Such robots have the drawback of requiring the presence of a trained operator nearby remotely controlling the drone, often due to legislative constraints. These robots cannot therefore carry out the diagnosis of the plots autonomously. In addition, due to their movement at altitude, drones cannot scan the underside of the canopy, limiting the nature of the data acquired.

WO 2014/111387 also discloses an automated agricultural robot that makes it possible to collect precision agriculture data and comprises movement optimization means in order to move non-randomly between plantation rows. Robots configured to produce maps of agricultural plots are also presented in RU 2 633 431. However, the configuration of these robots leads to deterioration of the crops they pass through.

Similarly, WO 2017/002093 relates to a robot designed for automatic weed treatment and comprising an image acquisition system for collecting data. WO 2006/063314 also describes a robot provided with sensors for measuring parameters of the plot. However, the size and bulk of these robots also cause crop deterioration as they pass.

WO 2019/040866 describes an autonomous field phenotyping robot that comprises a multispectral sensor and is designed to avoid damaging plantations. However, the embodiment described in this document proposes a robot comprising four wheels, which is suitable only for crops, in particular, corn, planted in rows between which the robot can move. However, this robot is not suitable for crops that are not in rows, in which it necessarily causes crop damage.

### BRIEF SUMMARY

The present disclosure therefore aims to remedy the drawbacks of the prior art by proposing an autonomous robot capable of scanning a plot in a complete manner with a view to carrying out a diagnosis that is adapted to many types and phenological stages of crops, especially for crops that are not in rows, while limiting its impact on crops as much as possible.

To do this, the present disclosure proposes an autonomous robot comprising a body that is elongated along an axis transverse to a direction of movement of the robot, and that includes, connected to the elongated body:
a multispectral sensor;
precisely two wheels; and
a stabilizing device for controlling the pitch of the elongated body when the wheels are in motion.

According to the present disclosure, the wheels are in the form of spoked wheels.

Compared with the robots of the prior art, such a robot therefore has the advantage of having only two wheels, which makes it possible to limit as much as possible the impact on the crops as it passes. The fact that the wheels are in the form of spoked wheels makes it possible to minimize the contact surface between the robot and the soil and allows the robot to straddle the plants without flattening them, which limits the impact of the wheels even further. The imbalance caused by the limitation to two wheels is compensated for by the presence of the stabilizing device.

According to other advantageous and non-limiting features of the present disclosure, either individually or in any technically feasible combination:
the elongated body has a substantially parallelepipedal or cylindrical shape with an axis transverse to the direction of movement of the robot;
the autonomous robot also comprises at least one motor configured to set the wheels in motion;
the motor is integrated in the elongated body;
the autonomous robot comprises two motors, each motor being associated with a wheel;
the autonomous robot also comprises energy storage means for supplying energy to the motor;
the energy storage means are integrated in a sealed compartment that is provided with a cover and fixed to the elongated body;
the autonomous robot has a sense of movement in the direction of movement and a center of gravity located to the rear of the transverse axis with respect to the direction of movement;
the stabilizing device is formed by a rod;
the rod is a bent rod comprising a straight proximal part and a curved distal part, the proximal part being connected to the elongated body, and the distal part being intended to be in contact with the soil when the wheels are in motion;
the distal part of the rod comprises a camera;
the rod is a rod that rotates about the axis of the proximal part of the rod;
the stabilizing device comprises means for moving the center of gravity of the autonomous robot on either side of the transverse axis;
the stabilizing device is formed by a rack-and-pinion system, which allows the rack to move along the direction of movement of the robot, the pinion being fixed to the elongated body, and the rack being formed by an elongated rod;
the spokes of the wheels are inclined with respect to the axis of the elongated body;
each spoke is provided with a shoe to reduce the impact of the wheel on the soil.

### BRIEF DESCRIPTION OF THE DRAWINGS

Other features and advantages of the present disclosure will become apparent from the following detailed description of example embodiments of the present disclosure, with reference to the accompanying drawings, in which:

FIG. 1A is an isometric perspective view of an autonomous robot according to a first embodiment of the present disclosure;

FIG. 1B is a side view of an autonomous robot according to the first embodiment of the present disclosure;

FIG. 1C is an isometric perspective view of an autonomous robot according to a second embodiment of the present disclosure; and

FIG. 2 is an isometric perspective view of the interior of an elongated body of an autonomous robot according to the present disclosure.

### DETAILED DESCRIPTION

For the sake of simplifying the following description, the same reference signs are used for elements that are identical or perform the same function in the different embodiments of the present disclosure.

General Description of the Autonomous Robot

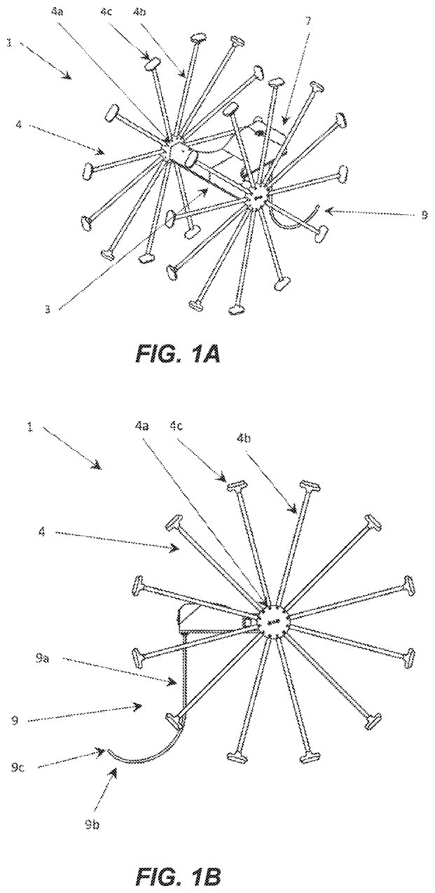

FIGS. 1A, 1B, and 1C represent, respectively, an isometric perspective view and a side view of an autonomous robot according to a first embodiment of the present disclosure, and an isometric perspective view of an autonomous robot according to a second embodiment of the present disclosure.

Such a robot 1 can, in particular, be used in the field of agriculture to collect data from an agricultural plot. For example, such data can enable characterization of the nutritional needs of the plants of the plot, or enable detection of the presence of bio-aggressors (weeds, diseases, pests, etc.) within the plot.

In this description, “autonomous” means that the robot 1 is capable of carrying out a certain number of automated tasks without requiring human, physical, or remote-controlled intervention. The robot can, in particular, be programmed to move alone within a plot, and to locate itself, for example by means of an integrated geolocation system, so as not to go past the perimeter of this parcel. The robot can also be programmed to locate itself in relation to surrounding objects and avoid collisions, for example, with other robots, humans, or vehicles. To this end, it can comprise proximity sensors of the sonar or lidar type or other instruments that are well known per se. It can also be programmed to collect data at regular time intervals.

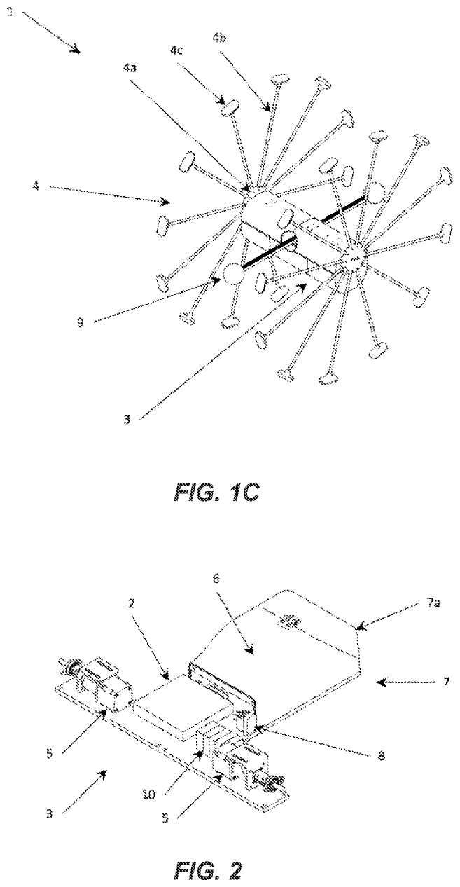

To this end, the autonomous robot 1 is provided with an on-board computer system 2, visible in FIG. 2, comprising, in particular, a processor, a memory unit, and all the other computer resources that make the robot capable of interpreting and executing instructions that may have been preset by the user. Such an on-board computer system 2 and such instructions are conventional and are not expanded upon in this description.

The autonomous robot 1 according to the present disclosure is designed to minimize the impact of its passage on the crops and to cover significant distances, typically covering 20 hectares per day, while benefiting from a stability sufficient to carry out the instructions on all terrains. To this end, the autonomous robot 1 has a low mass, advantageously less than 20 kilograms, less than 15 kilograms, or even less than 10 kilograms. A low mass has the advantage of limiting both the damage to the plants and the compaction of the soil, which smothers microbial life.

Returning to the description of FIGS. 1A to 1C, an autonomous robot 1 according to the present disclosure comprises a body 3 that is elongated along an axis transverse to a direction of movement of the robot 1.

Advantageously, the elongated body 3 has a substantially parallelepipedal or cylindrical shape, the axis of which is the axis transverse to the direction of movement, in order to minimize its volume and its bulk.

The robot 1 also comprises, connected to the elongated body 3, two wheels 4 arranged on either side of the elongated body 3 along the transverse axis. According to the present disclosure, the robot 1 comprises precisely two wheels, i.e., it does not have a third wheel or additional wheels capable of increasing the deterioration of the terrain as it passes.

According to the present disclosure, the wheels 4 are in the form of spoked wheels. A spoked wheel 4 includes a hub 4a directly connected to the elongated body 3, and a plurality of spokes 4b fixed to the hub 4a and extending radially from the hub 4a. The spoked wheel 4 is free of any element joining the spokes 4b, such as a hoop or a tire, with the exception of the hub 4a.

This form of wheel 4 is advantageous compared with the wheels usually described in the documents of the prior art because it limits the contact surface area between the robot and the soil and avoids flattening the plants as the robot passes, the spokes straddling the plants when the robot 1 is in motion.

The number of spokes 4b can be variable, and can advantageously be between six and twenty, advantageously eight, ten, or twelve spokes. Similarly, the size of the spokes 4b can be adjusted according to the needs and the nature of the plot and can advantageously be between 20 cm and 1 meter. In particular, it is possible to choose the size of the spokes according to the nature of the planes, so that the elongated body 3 of the robot 1 is arranged overhanging these planes and thus minimizes the impact of its passage on the crops. All the spokes 4b can be of the same size in order to give a generally circular shape to the wheel 4. However, such a choice is in no way limiting of the present disclosure, and it may appear advantageous to provide spokes 4b of different sizes from each other, for example, by alternating a longer radius and a shorter radius, in order to give a different shape to the wheel 4.

In general, the number and size of the spokes 4b determine the space between two points of contact with the soil as well as the straddling of the plants. They can thus be adjusted according to the needs of the user and the nature of the plot and the plants, as well as the current phenological stage of the crop on the plot. This gives the robot 1 significant modularity as well as great adaptability to different types of terrain.

Particularly advantageously, each spoke 4b can be provided with a shoe 4c to reduce the impact of wheel 4 on the soil. Such shoes 4c are thus shaped to minimize their sinking into loose soil, as shown in FIGS. 1A to 1C. It is also possible to provide more sophisticated shoes, such as those described in WO 94/20313.

The size of the shoes 4c is also preferably chosen to limit the contact surface with the soil while avoiding sinking into the soil. Typically, the surface of the shoes can be between 10 and 20 cm², with e.g., a width of 2 cm for a length of 6 cm, for example.

It is possible to provide a counter-camber of the wheels 4, so that the plane formed by the spokes 4b of the wheels 4 is inclined with respect to the axis of the elongated body 3, and the angle formed between the interior of the wheels 4 and the soil is an acute angle. Such a negative camber angle, advantageously between −1 and −20°, gives the robot 1 better support on the soil, in particular, when it makes turns. Preferably, if the wheels 4 are driven by a motor, all the mechanical parts involved in the movement of the wheels, namely the motor, the hub 4a, and the spokes 4b, are inclined. This makes it possible to limit the wear of these mechanical parts when the wheels 4 are in motion.

The material for forming the spokes 4b is advantageously chosen from light and inexpensive materials, for example, carbon fiber, fiberglass or, preferably, aluminum. Advantageously, the material is also relatively flexible, for example, aluminum, in order to absorb and dampen the shocks associated with overcoming obstacles. Such flexibility thus makes it possible to avoid the risk that the spoke will bend or break following an impact.

FIG. 2 is an isometric perspective view of the interior of the elongated body 3 according to a preferred embodiment of the present disclosure.

The robot 1 can comprise a motor 5 configured to set the wheels 4 in motion. When it advances, the robot 1 thus moves along a direction of movement in a sense of movement.

Advantageously, the motor can be integrated in the elongated body 3, as can be seen in FIG. 2, which allows the motor 5 to be protected from external attacks (water, dust, etc.). If the on-board computer system 2 is also integrated in the elongated body 3, it can be electrically connected to the motor 5 in order to provide it with instructions relating to the setting in motion of the wheels 4. Of course, the present disclosure is in no way limited to such configurations, and the motor 5 can be arranged outside the elongated body 3 and can, for example, be fixed to the wheel 4.

The robot 1 can contain a single motor 5 that simultaneously drives the two wheels 4.

However, according to a preferred embodiment of the present disclosure, shown in FIG. 2, the robot 1 comprises two motors 5, each motor 5 being associated with a wheel 4. In this configuration, the two motors 5 can independently drive the wheels 4. Such a configuration is of particular relevance for allowing the robot 1 to make a turn, since it is then possible to block a wheel 4 while continuing to move the other wheel 4 forward, the first wheel serving as a pivot about which the robot 1 will turn. It is also possible for the robot 1 to perform a U-turn on itself since it is possible to rotate one wheel 4 in one rotational direction while rotating the other wheel 4 in the opposite rotational direction. Such a possibility allows the robot 1 to occupy minimal space when changing direction, which is particularly useful in the case of crops, which are not in rows.

The robot 1 can also include energy storage means 6, such as a battery. It may, in particular, be a lead or nickel battery or a lithium battery.

The battery 6 can advantageously be integrated in a sealed compartment 7 provided with a cover 7a allowing access to the battery 6, the sealed compartment 7 being fixed to the elongated body 3. Alternatively, the battery 6 can also form the cover 7a itself. Preferably, the sealed compartment 7 is fixed to the rear of the elongated body 3 in the sense of movement, in order to shift the center of gravity of the robot 1 to the rear of the transverse axis with respect to the direction of movement. The advantage of such a feature will be expanded on in the remainder of the description.

The battery 6 makes it possible to supply the entire electrical system, and, in particular, the on-board computer system 2 and the motor(s) 5, with electricity.

The robot 1 can be provided with photovoltaic panels (not shown in the drawings) to supply electrical energy to the battery 6 and recharge it and make it possible to increase the autonomy and the operating time of the robot 1. These photovoltaic panels can be arranged on the elongated body 3, on the sealed compartment 7, or on a central zone on the outside of the wheels 4.

The robot 1 can also comprise a switch 8 that is arranged outside the elongated body 3 and connected to the on-board computer system 2, making it possible to switch the system on or off or more generally to interact with the electrical elements. In this respect, the robot 1 may comprise a battery control system, more commonly denoted by the term BMS (battery management system), making it possible to view the state of charge of the battery, or more generally the operating state of the device. This system can have an interface in the form of a display system, for example, of the LED or LCD type.

Stabilizing Device

Returning to the description of FIGS. 1A to 1C, the autonomous robot 1 also comprises a stabilizing device 9 to control the pitch of the elongated body 3 when the wheels 4 are in motion.

The presence of two wheels 4, which makes it possible to limit the impact of the robot 1 on the crops, necessarily leads to an imbalance of the elongated body 3 when the robot 1 is in motion. In addition, the spoke shape of the wheels 4 requires carrying out one step for each spoke. The applicant has thus noted that the low weight of the elongated body 3, even increased by the weight of the battery 6, is not sufficient to allow the wheels to perform the step. During operation of the motor(s) 5, the applicant has found that it is the elongated body 3, and not the wheels 4, which turns on itself.

### First Embodiment of the Stabilizing Device

According to a first embodiment, shown in FIGS. 1A and 1B, the center of gravity of the autonomous robot 1 is kept stationary to the rear of the transverse axis with respect to the sense of movement, for example, due to the sealed compartment 7 being fixed to the rear of the elongated body 3.

In this embodiment, the stabilizing device 9 is a passive stabilizing device formed by a rod. The rod 9 is preferably arranged to the rear of the elongated body 3, for example, rigidly attached to the sealed compartment 7, and is intended to touch the soil when the robot 1 is in motion. In this way, the rod 9 opposes the torque created by the motor(s) 5 and makes it possible to block the elongated body 3 according to a determined pitch angle, imposing the rotation of the wheels 4 and preventing the elongated body 3 from turning on itself.

Advantageously, and as is clearly visible in FIG. 1B, the rod 9 is a bent rod comprising a straight proximal part 9a and a curved distal part 9b, i.e., the end of the rod is oriented and raised upward, as is clearly visible in FIG. 1B. The proximal part 9a is connected to the elongated body 3, and preferably rigidly attached to the sealed compartment 7. The distal part 9b is intended to be in contact with the soil, in particular, when the wheels 4 are in motion. The curved aspect of the part of the rod in contact with the soil makes it possible to limit its impact on the crops, and not to snag, scratch, or uproot the plants crossed by the robot 1. In addition, this curved shape makes it possible to avoid the rod 9 sinking into the soil, the contact surface with the soil of the distal end 9b increasing when the distal end begins to sink into the soil. This property is very advantageous, in particular, when the soil is loose, which is frequently the case with agricultural plots.

Advantageously, the distal part of the rod, at least at the curved portion, has an oval or circular section so as to form a punctiform contact (when the soil is rigid) and to slide better over obstacles.

The low weight of the robot 1 makes it possible to prevent the rod 9 from creating furrows on the soil, which would have been the case with a third wheel. The presence of a rod also makes it possible to eliminate the phenomena of miring observed with the use of an additional wheel.

Preferably, the rod 9 is a rotatable rod, capable of pivoting about the axis formed by the straight proximal part 9a of the rod 9. The rod 9 is therefore not rigid during the movement of the robot 1 and can follow the movement of the robot, in particular, when it makes turns, without marking the soil. The rod 9 can thus pivot freely on itself when it encounters an obstacle or when the robot 1 makes a turn instead of sliding and/or translating rigidly with the movement of the robot while flattening any plants present in its vicinity. Stops can be provided to limit the angular displacement of the rod.

Alternatively to this embodiment in which the rod can pivot freely on itself, the rotation of the rod 9 can be controlled by the on-board computer system 2 in order to control the position of the rod 9, as will be detailed below.

The proximal part 9a can be fixed perpendicularly to the sealed compartment 7 and kept substantially vertical when the robot 1 is in motion, in order to guarantee that the compartment 7 and the elongated body 3 are kept substantially horizontal, protecting the elements integrated inside from too great an angle and pitch amplitude. The proximal part 9a can also be tilted backward in the sense of movement in order to mitigate the contact between the distal part 9b and the soil, the angle between the proximal part 9a and the elongated body 3 having to be close to 90° so as not to apply excessive force on the connecting parts, such as ball bearings, in particular, between the sealed compartment 7 and the rod 9.

### Second Embodiment of the Stabilizing Device

According to a second embodiment, shown in FIG. 1C, the stabilizing device 9 is an active stabilizing device, comprising means for moving the center of gravity of the autonomous robot 1 on either side of the transverse axis in the direction of movement.

This embodiment makes it possible to adjust at any time the position of the center of gravity of the robot 1 with respect to the elongated body 3, in order to control the pitch of the body.

In particular, when the robot 1 is set in motion, the stabilizing device 9 can move the center of gravity away from the transverse axis in the sense of movement to unbalance the robot 1 and allow it to be set in motion. Once set in motion, the center of gravity is restored to the rear, toward the transverse axis, to establish a new balance.

Then, when the robot 1 is in motion, the stabilizing device 9 forms the counterweight necessary for the spokes 4b to carry out the step, the dynamic offset of the counterweight allowing the movement. During the movement, the center of gravity thus permanently oscillates between the front of the robot 1 in the sense of movement, to enable it to move forward, and the rear of the robot 1, in order to limit its runaway.

The offset of the counterweight toward the rear of the robot, in the usual sense of movement of the robot 1, combined with a change in the direction of rotation of the wheels 4 controlled by the motor(s) 5, can also make it possible to set the robot 1 in motion in the opposite sense. This operation allows the robot 1 to reverse on the same course, without having to make a turn, in order to reverse its sense of movement.

Preferably, the stabilizing device 9 is formed by a rack-and-pinion system allowing the rack to move in the direction of movement of the robot 1.

In this situation, the pinion is fixed to the elongated body 3. The rack is formed by an elongated rod forming a counterweight.

The movement of the rack along the direction of movement of the robot 1 makes it possible to control the offset of the counterweight and the distance of the center of gravity with respect to the transverse axis of the elongated body 3.

This movement can be mechanical with the aim of maintaining a position of equilibrium and maintaining the elongated body in a determined pitch angle. However, this movement can also be automated, the movement of the rack being controlled by the on-board computer system 2, either according to pre-established instructions, or on the basis of the parameters of the situation. For example, the on-board computer system 2 can be instructed to control a slight imbalance of the elongated body 3 when it is set in motion, and then to control a dynamic balance during the movement. This dynamic balance can, in particular, take into account the irregularities of the soil or the slopes likely to unbalance the robot 1. To this end, the on-board computer system 2 can be associated with an inertial unit (not shown), which consists of an inclinometer, an accelerometer, and/or a gyroscope, and is fixed to the elongated body 3.

Data Collection

The autonomous robot 1 according to the present disclosure is intended to collect data from the environment that surrounds the robot 1, for example, to detect the presence of weeds or insects, or capturing the radiation emitted by plants. The analysis of the radiation emitted by the plants makes it possible to monitor the nutritional needs of the plant, in particular, the water requirement and the nitrogen content. This last aspect is known, in particular, from WO 99/19824 and is not described in detail in the present description.

To enable it to collect data, the autonomous robot 1 comprises at least one multispectral sensor 10.

The use of multispectral sensors in the field of precision agriculture is well known per se and is therefore not expanded upon within the scope of this description.

This multispectral sensor 10 can be arranged inside the elongated body 3 and can be connected to the on-board computer system 2 to receive instructions and to the battery 6 for electrical supply. Advantageously, the multispectral sensor 10 is arranged on an underside of the elongated body 3 in order to be able to analyze the canopy that the sensor 10 overlooks. Of course, the present disclosure is in no way limited to such localization. Furthermore, the robot 1 can comprise a plurality of multispectral sensors.

The autonomous robot 1 can also comprise other data collection instruments, such as visible or infrared cameras. Cameras can thus be integrated in the elongated body 3, in the sealed compartment 7, or even fixed to one of the spokes 4b.

Advantageously, if the stabilizing device 9 is formed by a bent rod, the distal part 9b of the rod 9, and specifically its free end, can also comprise a camera 9c. This localization makes it possible to have a camera, which is very close to the soil and oriented upward, and thus to collect data from the underside of the canopy. In addition, the rotatable nature of the rod 9 makes it possible, if the rod is controlled by the on-board computer system 2, to carry out a very broad exploration of the environment around the robot 1.

Optionally, the distal part 9b of the rod 9 can also comprise an LED or other light source in order to illuminate the underside of the canopy to improve the quality of the images acquired by the camera 9c, for example by attenuating any effects of shade.

The robot 1 may also comprise a device for recording the data collected by the data collection instruments. This recording device can be integrated in the elongated body 3 and coupled to the on-board computer system 2 to receive the recording instructions. The recording device can be, or can be associated with, a removable recording card, such as an SD card, which the user can remove from the robot 1 to recover the data collected and analyze the data, or directly recover the data analyzed by a data analysis device.

The robot 1 can therefore also comprise a data analysis device that is coupled to the recording device or to the on-board computer system 2, making it possible to analyze the data collected and recorded and to record the analysis carried out on the recording device.

Alternatively, or in addition, the recording device may include remote communication means using radio frequencies, such as BLUETOOTH®, Wi-Fi™, 2G, 3G, 4G, 4G+, 5G, ZIGBEE™, LoRA®, and/or Sigfox™, for example, in order to be able to remotely transmit the collected data or the analyzed data to the user. Of course, the present disclosure is not limited to the embodiments described and it is possible to add variants without departing from the scope of the invention as defined by the claims.

In particular, the present disclosure is not limited to the embodiments of the stabilizing devices described. It is entirely possible to conceive of stabilizing devices other than a rod or a rack-and-pinion system, such as an active gyroscope or a pendulum, for example.

1. An autonomous robot, comprising:
an elongated body elongated along an axis transverse to a direction of movement of the robot;
a multispectral sensor connected to the elongated body;
precisely two wheels connected to the elongated body, each of the two wheels comprising spokes and being free of any element joining the spokes with the exception of a hub; and
a stabilizing device connected to the elongated body, the stabilizing device configured to control a pitch of the elongated body when at least one of the two wheels is in motion.

2. The robot of claim 1, further comprising at least one motor configured to set at least one of the two wheels in motion.

3. The robot of claim 2, wherein the at least one motor is in the elongated body.

4. The robot of claim 3, wherein the at least one motor comprises two motors, each of the two motors being associated respectively with one wheel of the two wheels.

5. The robot of claim 4, further comprising energy storage means for supplying the two motors with energy, the energy storage means being disposed in a sealed compartment provided with a cover and fixed to the elongated body.

6. The robot of claim 5, wherein a center of gravity of the robot is located to a rear of the transverse axis with respect to an intended direction of movement of the robot.

7. The robot of claim 6, wherein the stabilizing device comprises a rod.

8. The robot of claim 7, wherein the rod is a bent rod comprising a straight proximal part and a curved distal part, the proximal part being connected to the elongated body, and the distal part being configured to contact soil when the wheels are in motion.

9. The robot of claim 8, wherein the distal part of the rod comprises a camera.

10. The robot of claim 9, wherein the rod is configured to rotate about the axis of the proximal part.

11. The robot of claim 5, wherein the stabilizing device comprises means for moving the center of gravity of the autonomous robot on either side of the transverse axis.

12. The robot of claim 11, wherein the stabilizing device comprises a rack-and-pinion system configured to enable the rack to move along the intended direction of movement of the robot, the pinion being fixed to the elongated body), and the rack being formed by an elongated rod.

13. The robot of claim 1, wherein a plane formed by the spokes of the wheels is inclined with respect to the axis of the elongated body.

14. The robot of claim 1, wherein each of the spokes is provided with a shoe configured to reduce the impact of the two wheels on the soil.

15. The robot of claim 2, wherein the at least one motor comprises two motors, each of the two motors being associated respectively with one wheel of the two wheels.

16. The robot of claim 2, further comprising energy storage means for supplying the at least one motor with energy, the energy storage means being disposed in a sealed compartment provided with a cover and fixed to the elongated body.

17. The robot of claim 1, wherein a center of gravity of the robot is located to a rear of the transverse axis with respect to an intended direction of movement of the robot.

18. The robot of claim 17, wherein the stabilizing device comprises a rod.

19. The robot of claim 1, wherein the stabilizing device comprises means for moving the center of gravity of the autonomous robot on either side of the transverse axis.

20. The robot of claim 19, wherein the stabilizing device comprises a rack-and-pinion system configured to enable the rack to move along the intended direction of movement of the robot, the pinion being fixed to the elongated body, and the rack being formed by an elongated rod.
